(19) United States
(12) Patent Application Publication
(10) Pub. No.: US 2005/0040367 A1
(43) Pub. Date: Feb. 24, 2005

(54) Stabilizer composition, production and use thereof

(75) Inventors: Stefan Fokken, Biberbach (DE); Juergen Hauk, Freising (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Baerlocher GmbH

(21) Appl. No.: 10/866,275

(22) Filed: Jun. 11, 2004

Related U.S. Application Data
(63) Continuation of application No. PCT/EP02/13881, filed on Dec. 6, 2002.

(30) Foreign Application Priority Data
Dec. 11, 2001 (DE) 101 60 662.1

(51) Int. Cl. C09K 15/22; C08K 5/34

(52) U.S. Cl. 252/403; 524/101

(57) ABSTRACT

The present invention is a stabilizer composition for halogen-containing polymers comprising at least one organic onium perchlorate and at least one organic solvent. The present invention also includes a solid stabilizer comprising at least one organic onium perchlorate and a stabilizer comprising phosphonium perchlorate. The present invention also includes a polymer composition containing the onium perchlorate stabilizer and a formed body comprising the polymer composition. The present invention further includes a process for producing the onium perchlorate stabilizer and a method of stabilizing polymers comprising mixing the onium perchlorate stabilizer with the polymer.

### CROSS-REFERENCE TO RELATED APPLICATIONS

This is a continuation application of PCT/EP02/13881, filed Dec. 6, 2002, which is incorporated herein by reference in its entirety, and also claims the benefit of German Priority Application No. 101 60 662.1, filed Dec. 11, 2001

### FIELD OF THE INVENTION

The present invention relates to a stabilizer composition for halogen-containing polymers, their production and their use.

### BACKGROUND OF THE INVENTION

As is known, under thermal load during processing or in long term use, halogen-containing plastics tend to undesired degradation and decomposition reactions. In the decomposition of halogenated polymers, in particular with PVC, hydrochloric acid forms, which is eliminated from the polymer strand, resulting in a coloured unsaturated plastic with chromophoric polyene sequences.

The effect is particularly problematic, since halogen-containing polymers only have the Theological properties necessary for processing at a relatively high processing temperature. At such temperatures, however, in unstabilized polymers a notable degradation of the polymer occurs, which leads both to the above-described undesired colour change and to an alteration of the material properties. Furthermore, the hydrochloric acid liberated from the non-stabilized, halogen-containing polymer at such a processing temperature leads to an appreciable corrosion of the processing installation. This process in particular plays a role, if in the processing of halogenated polymers of this type into formed bodies, for example by extrusion, interruptions of production occur and the polymer mass remains for a longer period of time in the extruder. During this time, the above degradation reactions can occur, whereby the charge in the extruder becomes unusable, and the extruder can also be damaged.

Furthermore, polymers which have been subjected to a degradation of this type tend to form adhesions to the processing installations, which are difficult to remove.

In order to solve the problems mentioned, compounds are generally added to halogen-containing polymers in processing as so-called stabilizers, which should prevent as much as possible the above-mentioned degradation reactions. Generally, stabilizers of this type are solids, which are added to the polymer to be processed before its processing.

As stabilizers, perchlorates for example are suitable, whereby the perchlorates according to the prior art are generally used as inorganic perchlorates, for example as sodium perchlorate. However, these compounds have the problematic effect that they are not adequate for the demands made of them.

Solid stabilizers often have, furthermore, the disadvantage that in particular with transparent processing forms, they can lead to undesired opacities in the end product. Cloudiness of this type limits, however, the acceptability of such end products to further processing users and hinders the use of the end product in applications which depend upon as high a degree of transparency as possible.

In order to counter this problem, for example, liquid sodium perchlorate-containing stabilizers have been proposed. These stabilizers have, however, the disadvantage that in the sense of an improvement of the starting colour, the stabilizer properties often leave something to be desired.

### SUMMARY OF THE INVENTION

The present invention had, therefore, the object of making available a stabilizer composition which can be used in the production of halogen-containing polymers and which leads to an improvement of the starting colour. Furthermore, the present invention had the object of making available a liquid stabilizer composition, which can be used in the production of halogen-containing polymers and which reduces cloudiness in transparent end products, for example of hard or soft PVC. A further object of the invention was to make available a stabilizer composition, which has an improvement of the starting colour in the processing of halogen-containing polymers in comparison to stabilizers known from the prior art.

It has now been found that solid and liquid stabilizer compositions which comprise at least one organic onium perchlorate solve the above-mentioned objects.

A first subject matter of the present invention is therefore a stabilizer composition which comprises an organic onium salt of perchloric acid and a mixture of two or more organic onium salts of perchloric acid and at least one organic solvent.

By “stabilizer composition” in the scope of the present invention is understood a composition which can be used for stabilizing halogen-containing polymers. To achieve this stabilizing effect, a stabilizer composition according to the invention is, generally, mixed and then processed with a halogen-containing polymer provided for stabilization. It is, however, also possible to mix a stabilizer composition according to the invention into the halogen-containing polymer to be stabilized during the processing.

By the term “liquid” in the scope of the present invention is understood the physical state of a stabilizer composition according to the invention at least within a temperature range of around 45 to around 100° C., preferably within a temperature range of around 30 to around 120° C., for example within a temperature range of around 15 to around 150° C. and in particular within a temperature range of around 0 to around 200° C.

By the term “solvent” in the context of the present text is understood a compound which can dissolve an organic onium salt of perchloric acid or a mixture of two or more organic onium salts of perchloric acid in a quantity of at least 0.1 wt. %. As “onium salt” in the scope of the present text is described a compound which represents an ammonium, sulfonium or phosphonium salt. An “onium salt” according to the present invention is an organic onium salt. This means that the ammonium, sulfonium or phosphonium groups of the onium salt bear at least one organic residue. An onium salt according to the present invention can thus, depending on the type of onium group, bear one, two, three or four organic residues. The organic residues can thus for example be linked to the onium residue via a C-X-linkage, wherein X represents S, N or P. It is, however, also possible, that the organic residues are linked to the onium residue via a further heteroatom, for example an 0 atom.

An onium perchlorate applicable in the scope of the present invention has at least one positively charged N, P or S atom or two or more of such positively charged N, P or S atoms or mixtures of two or more of the mentioned, positively charged atom types.

In the scope of the present invention, as onium perchlorate compounds which bear at the N, S or P atom at least one organic residue and at most the highest possible number of organic residues are used. If an onium perchlorate applicable according to the invention bears fewer organic residues than are necessary to form a positively charged onium ion, the positive charge is achieved by common means known to the skilled person via protonation by means of a suitable acid, so that the corresponding onium perchlorate in this case bears, in addition to an organic residue, at least one proton.

Thus according to the invention compounds can be used as onium perchlorates which by reason of protonation reactions have a positive charge. It is, however, likewise possible in the scope of the stabilizer combinations according to the invention to use onium perchlorates, which by reason of a peralkylation reaction have a positive charge. Examples of compounds of this type are tetraalkylammonium, trialkylsulfonium or tetraalkylphosphonium perchlorates. It is, however, likewise provided in the scope of the present invention that a peralkylated onium perchlorate applicable according to the invention has an aryl, alkaryl, cycloalkyl, alkenyl, alkynyl or cycloalkenyl residue. It is, according to the invention, likewise possible and provided, that an onium salt applicable in the framework of a stabilizer composition according to the invention has two or optionally more different substituent types, for example an alkyl and a cycloalkyl residue or an alkyl and an aryl residue.

It is also, in the scope of the present invention, possible and provided that an onium salt which can be used in the stabilizer composition according to the invention has substituents which are in turn substituted by one or more functional groups. As “functional groups” are indicated groups which improve the effects of the stabilizer composition or at least do not or only insubstantially worsen them. Corresponding functional groups can be, for example, NH groups, NH₂ groups, OH groups, SH groups, ester groups, ether groups, thioether groups, isocyanurate groups or keto groups or mixtures of two or more thereof.

### DETAILED DESCRIPTION OF THE PREFERRED EMBODIMENTS

As phosphonium perchlorate, in the scope of the present invention in principle all compounds can be used which lead by corresponding conversion of suitable reactants to a phosphonium perchlorate. Thus phosphonium perchlorates which can be used according to the invention are obtained for example by corresponding conversion of tetraalkyl-, tetracycloalkyl-, or tetraallylphosphorus halides. Suitable phosphonium perchlorates are derived, therefore, for example from tetraalkylphosphorus salts such as tetra-n-ethylphosphoniumbromide, tetra-n-propylphosphoniumbromide, tetra-n-butylphosphoniumbromide, tetra-n-isobutylphosphoniumbromide, tetra-n-pentylphosphoniumbromide, tetra-n-hexylphosphoniumbromide and tetraalkylphosphorus salts of this type. Furthermore, in principle phosphonium perchlorates are suitable for use in the scope of these stabilizer compositions according to the invention, which are derived for example from tetracycloalkylphosphorus salts or tetraarylphosphorus salts. Suitable phosphonium perchlorates are based thus for example on tetracycloalkyl- or tetraarylphosphorus salts such as tetracyclohexylphosphonium bromide or tetraphenylphosphonium bromide and tetracycloalkyl- or tetraaryl phosphorus salts of this type. The above-mentioned compounds can, in the scope of the present invention, be unsubstituted; they can, however, also have one or more of the above-mentioned substituents, in so far as these substituents do not have any disadvantageous affects in the scope of the stabilizer composition and do not disadvantageously influence the purpose of the use of the stabilizer composition.

Likewise useable in the framework of the present invention are organic phosphonium perchlorates, which can bear different types of organic substituents at a phosphorus atom, which can optionally be differently substituted.

Preferred embodiments of the present invention, using phosphonium perchlorates, include tetra-n-butylphosphonium perchlorate or triphenylbenzylphosphonium perchlorate.

As sulfonium perchlorates, in the scope of the present invention, in principle all compounds are useable which, by means of corresponding conversion of suitable reagents, lead to a sulfonium perchlorate. Thus useable sulfonium perchlorates according to the invention can, for example, be obtained by corresponding conversion of sulfides such as alkylmonosulfides, alkyldisulfides, dialkylsulfides or polyalkylsulfides. Suitable sulfonium perchlorates are thus derived, for example, from dialkylsulfides such as ethylbenzylsulfides, allylbenzylsulfides or alkyldisulfides such as hexanedisulfides, heptanedisulfides, octanedisulfides and alkyldisulfides of this type. Furthermore, in principle, for use in the scope of the stabilizer composition according to the invention, sulfonium perchlorates are suitable, which are derived, e.g., from tricycloalkylsulfonium salts or triarylsulfonium salts. Suitable sulfonium perchlorates are thus based, e.g., on tricycloalkyl- or triarylsulfonium salts such as tricyclohexylsulfonium bromide or triphenylsulfonium bromide and tricycloalkyl- or triarylsulfoniumsalts of this type. Likewise suitable are trialkyl-, triaryl- or tricycloalkylsulfoxonium salts such as trimethylsulfoxonium perchlorate. The above-mentioned compounds can, in the scope of the present invention, be unsubstituted; they can however also have one or more of the above-mentioned substituents, provided that these substituents have no disadvantageous effects in the scope of the stabilizer composition and do not negatively influence the purpose of the stabilizer composition.

Likewise useable in the scope of the present invention are organic sulfonium perchlorates which have organic substituents of different types at a sulphur atom, which can optionally be differently substituted.

A preferred embodiment of the present invention using sulfonium perchlorate includes trimethylsulfoxonium perchlorate.

As ammonium perchlorate, in the scope of the present invention, in principle all compounds are useable which by corresponding conversion of suitable reagents lead to an ammonium perchlorate. Thus useable ammonium perchlorates according to the invention can, e.g., be obtained by corresponding conversion from amines or amides such as alkylmonoamines, alkylenediamines, alkylpolyamines, secondary or tertiary amines or dialkylamines. Suitable ammonium perchlorates are thus derived, e.g., from primary mono- or polyamino compounds with 2 to approximately 40, e.g. 6 to approximately 20 C-atoms. These are, e.g. ethylamine, n-propylamine, i-propylamine, n-butylamine, sec.-butylamine, tert.-butylamine, substituted amines with 2 to approximately 20 C-atoms such as 2-(N,N-dimethylamino)-1-aminoethane. Suitable diamines have, e.g., 2 primary, 2 secondary, 2 tertiary or one primary and one secondary or one primary and one tertiary or one secondary and one tertiary amino group. Examples thereof are diaminoethane, isomers of diaminopropane, the isomers diaminobutane, the isomers diaminohexane, piperazine, 2,5-dimethylpiperazine, amino-3-aminomethyl-3,5,5-trimethylcycohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane or tertiary amines such as triethylamine, tributylamine, dimethylbenzylamine, N-ethyl-, N-methyl-, N-cyclohexylmorpholine, dimethylcyclohexylamine, dimorpholinodiethylether, 1,4-diazabicyclo[2,2,2]octane, 1-azabicyclo[3,3,0]octane, N,N,N′,N′-tetramethylethylenediamine, N,N,N′,N′-tetramethylbutanediamine, N,N,N′,N′-tetramethylhexanediamine-1,6, pentamethyidiethylenetriamine, tetramethyldiaminoethylether, bis-(dimethylaminopropyl)-urea, N,N′-dimethylpiperazine, 1,2-dimethylimidazole or di-(4-N,N-dimethylaminocyclohexyl)-methane.

Likewise suitable are aliphatic amino alcohols with 2 to approximately 40, preferably 6 to approximately 20 C-atoms, e.g. triethanolamine, tripropanolamine, tributanolamine, tripentanolamine, 1-amino-3,3-dimethyl-pentan-5-ol, 2-aminohexan-2′,2″-diethanolamine, 1-amino-2,5-dimethylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentane-methanol, 2-amino-2-ethyl-1,3-propandiol, 2-(dimethylaminoethoxy)-ethanol, aromatic-aliphatic or aromatic-cycloaliphatic amino alcohols with 6 to around 20 C-atoms, wherein as aromatic structures, heterocyclic or isocyclic ring systems such as naphthalene derivatives or in particular benzene derivatives such as 2-aminobenzylalcohol, 3-(hydroxymethyl)aniline, 2-amino-3-phenyl-1-propanol, 2-amino-1-phenylethanol, 2-phenylglycinol or 2-amino-1-phenyl-1,3-propandiol as well a mixtures of two or more of such compounds, are used.

In the scope of a further embodiment of the present invention, as ammonium perchlorate, the perchlorates of heterocyclic compounds are used, which have available a cyclic ring system comprising amino groups.

E.g., the perchlorates of heterocyclic amino alcohols are used, which comprise at least 2, preferably at least 3 amino groups in the ring. As central ring component of the ammonium perchlorates useable according to the invention, particularly suitable are the trimerisation products of isocyanates.

Thus e.g. suitable hydroxyl group-containing isocyanurates are of the general formula I 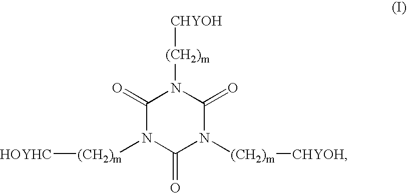
whereby the groups Y and the indices m are respectively the same or different and m stands for a whole number from 0 to 20 and Y for a hydrogen atom or a linear or branched, saturated or unsaturated alkyl group with one to approximately 10 C-atoms. Particularly preferred according to the present invention is the use of tris(hydroxyethyl)isocyanurate (THEIC) as a component of the stabilizer composition according to the invention.

Likewise suitable as ammonium perchlorate are, e.g., compounds in which the amino group is present bound to a substituted aromatic or heteroaromatic system, e.g., aminobenzoic acid, aminosalicylic acid or aminopyridinecarboxylic acid and suitable derivatives thereof.

Preferred embodiments of the present invention using an ammonium perchlorate include 2-ethylcarboxypyridinium perchlorate, formamidinium perchlorate, tetra-n-butylphosphonium perchlorate, trimethylsulfoxonium perchlorate, the perchlorate salt of trishydroxyethylisocyanurate, the perchlorate salt of 2-(diethylamino)-ethanol, N-(2-hydroxyethyl)-morpholinium perchlorate, trioctylammonium perchlorate, or mixtures of two or more thereof.

A stabilizer composition according to the invention can, in the scope of the present invention, e.g. comprise only one of the above-mentioned onium perchlorates. It is, in the scope of the present invention, likewise possible and also provided, that a stabilizer composition according to the invention comprises a mixture of two or more of the above-mentioned onium perchlorates. These can be a mixture of two or more different types of onium perchlorates, i.e., for example a mixture of ammonium perchlorates and sulfonium perchlorates or ammonium perchlorates and phosphonium perchlorates or sulfonium perchlorates and phosphonium perchlorates or ammonium perchlorates and sulfonium perchlorates and phosphonium perchlorates. It is in the scope of the invention also possible that a stabilizer composition according to the invention comprises a mixture of two or more onium perchlorates of a type, i.e. a mixture of two or more ammonium perchlorates and a mixture of two or more sulfonium perchlorates and a mixture of two or more phosphonium perchlorates.

If a stabilizer composition according to the invention comprises a mixture of two or more onium perchlorates, these two or more onium perchlorates can in principle be present in the stabilizer composition according to the invention in any proportions.

A stabilizer composition according to the invention comprises, in the scope of the present invention, based on the total composition, 0.01 to approximately 30 wt.-%, e.g. approximately 0.1 to approximately 20 wt.-% of an organic onium salt of a perchlorate or of a mixture of two or more organic onium salts of perchlorates.

A stabilizer composition according to the invention in the scope of the present invention preferably comprises as organic onium salt an ammonium or a sulfonium salt or a mixture of two or more thereof, in particular an ammonium salt.

If a stabilizer composition according to the invention is present in the liquid state, it can have, besides an onium perchlorate, e.g. one or more of the following listed solvents or one or more of the following additives.

A stabilizer composition according to the invention comprises, besides an onium perchlorate or a mixture of two or more onium perchlorates, at least one organic solvent.

By a “solvent” is understood, in the scope of the present invention, a compound or a mixture of two or more compounds which within a given temperature range is liquid and therefore in a position to dissolve an onium perchlorate or a mixture of two or more of such onium perchlorates present in a composition according to the invention. A suitable solvent in the scope of the present invention is liquid at least within a temperature range from approximately 45 to approximately 100° C., preferably within a temperature range from approximately 30 to approximately 120° C., e.g. within a temperature range of approximately 15 to approximately 150° C. and in particular within a temperature range of approximately 0 to approximately 200° C.

A preferred embodiment of the present invention uses as a solvent compounds or mixtures of two or more compounds which are suitable as softeners for halogen-containing polymers.

Thus, compounds suitable as solvents include, for example, compounds from the group of phthalic acid esters such as dimethyl-, diethyl-, dibutyl-, dihexyl-, di-2-ethylhexyl-, di-n-octyl-, di-iso-octyl-, di-iso-nonyl-, di-iso-decyl-, dicyclohexyl-, dimethylcyclohexyl-, dimethylglycol-, dibutylglycol-, benzylbutyl- or diphenylphthalate as well as mixtures of phthalates, e.g. mixtures of alkylphthalates with 7 to 9 or 9 to 11 C-atoms in the ester alcohol or mixtures of alkylphthalates with 6 to 10 and 8 to 10 C-atoms in the ester alcohol. Particularly suitable in the sense of the present invention are thus dibutyl-, dihexyl-, di-2-ethylhexyl-, di-n-octyl-, di-iso-octyl-, di-iso-nonyl-, di-iso-decyl-, di-iso-tridecyl- and benzylbutylphthalate as well as the mentioned mixtures of alkylphthalates.

Further suited as solvents are the esters of aliphatic dicarboxylic acids, in particular the esters of adipinic, azelaic or sebacic acid or mixtures of two or more thereof. Examples of solvents of this type are di-2-ethylhexyladipate, di-isooctyladipate, di-iso-nonyladipate, di-iso-decyladipate, benzylbutyladipate, benzyloctyladipate, di-2-ethylhexylazelate, di-2-ethylhexylsebacate and di-iso-decylsebacate. Preferred in the scope of a further embodiment of the present invention are di-2-ethylhexylacetate and di-iso-octyladipate.

Likewise suitable as solvent are trimellitic acid esters, such as tri-2-ethylhexyl-trimellitate, tri-iso-tridecyltrimellitate, tri-iso-octyltrimellitate as well as trimellitic acid esters with 6 to 8, 6 to 10, 7 to 9 or 9 to 11 C-atoms in the ester groups or mixtures of two or more of the compounds mentioned.

Further suitable solvents are, e.g. polymer softeners, as given in “Kunststoffadditive”, R. Gatchter/H. Muller, Carl Hanser Verlag, 3rd Edition, 1989, chapter 5.9.6, pages 342-489, or , PVC Technology”, W. V. Titow, 4th Edition, Elsevier Publishers, 1984, pages 165-170. Reference is hereby explicitly made to the named publications and to the softeners named in the scope of the first named source of information (R. Gachter/H. Muller) and suitable as solvents in the sense according to the invention, in particular the compounds mentioned in tables 9a (pages 388 to 392), 10 (page 396), 11 (page 400), 12a (pages 402 to 404), 13a (pages 408 to 410), 13b (page 412), 14 (page 413), 16 (page 418), 3(page 479) and 4 (pages 486 to 488), which are incorporated by reference and considered as part of the disclosure of the present text.

The most common starting materials for the production of polyester softeners are dicarboxylic acids such as adipinic, phthalic, azelainic or sebacic acids as well as diols such as 1,2-propanediol, 1,3-butanediol, 1,4-butanediol, 1,6-hexanediol, neopentylglycol or diethyleneglycol or mixtures of two or more thereof.

Likewise suitable as softeners are phosphoric acid esters, as to be found in “Taschenbuch der Kunststoffadditive”, chapter 5.9.5, pages 408 to 412. Examples of suitable phosphoric acid esters are tributylphosphate, tri-2-ethylbutylphosphate, tri-2-ethylhexylphosphate, trichlorethylphosphate, 2-ethyl-hexyl-di-phenylphosphate, triphenylphosphate, tricresylphosphate or trixylenylphosphate, or mixtures of two or more thereof.

Particularly suited as solvent in the scope of the present invention are the following listed compounds: 2-hydroxy-5-methyl-benzoic acid methylester, 2-ethoxybenzyl alcohol, N-ethyl-2,3-dimethylaniline, 2-Hydroxy-3-methyl-benzoic acid methylester, lauric acid benzylester, 3,4,5-trimethoxybenzyl alcohol, 3,5-dimethylbenzyl alcohol, 3-methylbenzophenone, 2-methoxyactetophenone, 3-cyclohexylpropionic acid, cyclopentanecarboxylic acid, 2,5-dimethylbenzonitrile, 4-(4-methoxyphenyl )-butan-2-one, formic acid cinnamic ester, triethylcitrate, decanedioic acid dibutylester, heptaethyleneglycol decanedioic acid diethylester, adipinic acid dibutylester, 1,2-bis(2-acetoxy-ethoxy)-ethane, azelaic acid diethylester, octanedioic acid diethylester, glutaric acid diethylester, myristinic acid ethylester, oxalic acid dibutylester, 9-decenylpropionate, lauric acid methylester, acetic acid decylester, cyanoacetic acid butylester, hexanoic acid pentylester, acetic acid nonylester, decanoic acid methylester, nonanoic acid methylester, undecylenealcohol, N-methyldioctylamine, Diethylenglycoldibutylether, Dioctylether, decan-3-one, 4-oxa-heptanedinitrile, nonanenitrile, diethyleneglycolmonohexylether, diisobutylketone, formic acid butylester, n-tridecylalcohol, butylcarbitol, glutaric acid dinitrile, propionic acid methylester, thioformic acid dimethylamide, octamethylenedimercaptan, 2-ethylhexan-1,3-diol, decan4-ol, decan-1-thiol, hexamethylenedimercaptan, trimethylene iodide, dodecan-2-ol, N-butylformamide, diisopentylsulfide, hexaethyleneglycol, pentaethyleneglycol, trioctylamine, dipropylenetriamine, triethyleneglycol, dodecylmercaptan, 2,2′-dithiodiglycol, diethylcarbonate, m-tolylisothiocyanate, linolenic acid, triethylentetraamine, 5H-furan-2-one, 4-benzylpiperidine, 1-phenylpiperidine, isonicotinic acid ethyl ester, pyridine-2-carboxylic acid ethyl ester, 2,3,3-trimethyl-3H-indole, 3-methylsulfolan, propylene carbonate, 3-piperidinopropionitril, sulfolane, tetrahydrothiophene-1 -oxide, 4-morpholinoethanol, or 4-octylanilin.

The above-mentioned solvents can be present in a stabilizer composition according to the invention respectively alone or as a mixture of two or more thereof. If a stabilizer composition according to the invention is a liquid stabilizer composition which comprises two or more of the above-mentioned compounds as solvent, one of the compounds or several of the compounds can lie outside the above-mentioned definition of the term “liquid”, as long as the total solvent mixture lies within this definition.

A stabilizer composition according to the invention comprises solvent or solvent mixture in a quantity of approximately 99.99 to approximately 2 wt.-%, e.g. approximately 98 to approximately 3 or approximately 95 to approximately 5 wt.-%. The solvent content can vary within a broad limit, depending on whether the stabilizer composition according to the invention is used as sole stabilizer or together with one or more additives or should be present in a solid or liquid state. Thus a liquid stabilizer composition according to the invention can e.g. have a proportion of solvent from approximately 20 to approximately 99.99 wt.-% or approximately 99 to approximately 30 wt.-% or approximately 95 to approximately 35 wt.-% or approximately 90 to approximately 40 wt.-% or approximately 85 to approximately 50 wt.-%.

In addition to an onium perchlorate or a mixture of two or more onium perchlorates, or an onium perchlorate or a mixture of two or more onium perchlorate and a solvent or a mixture of two or more solvents, a stabilizer composition according to the invention can comprise one or more further additives in a quantity of up to approximately 95 wt.-%, e.g. up to approximately 93 wt.-% or approximately 91 wt.-% or approximately 0 to approximately 90 wt.-% or approximately 1 to approximately 85 wt.-%.

These are preferably additives which distribute themselves in a polymer to be stabilized in such a way, preferably dissolve in such a way, that a stabilized polymer does not become opaque by means of the additive.

The production of solid stabilizer compositions according to the present invention is carried out in principle with each method known to the skilled person for mixing different solid or solid and liquid substances, e.g. by simple mixing of an onium perchlorate with further additives.

The production of the liquid stabilizer composition according to the invention occurs in different ways. In principle, for the production of a stabilizer composition according to the invention, it is e.g. possible to dissolve an onium perchlorate in a suitable organic solvent.

The subject matter of the present invention is thus a process for producing a stabilizer composition according to the invention, in which an onium perchlorate is dissolved in an organic solvent.

Since many of the onium perchlorates usable in the scope of the present process and in a stabilizer composition according to the invention are not commercially obtainable and thus must be produced by the user themselves, this lends itself to the integration of the process for producing the onium perchlorate into the process according to the invention for producing the stabilizer composition according to the invention. To this end different procedures can be selected, from which a selection is described by an example in the following.

It is thus, e.g., in principle possible, to first produce, from an organic compound which is capable of forming an onium salt or a salt of such a compound, by conversion with perchloric acid or with a suitable inorganic salt of perchloric acid, to produce an onium perchlorate. This onium perchlorate can then be isolated and dissolved in an appropriate organic solvent. The conversion occurs preferably in aqueous solution, whereby the perchloric acid or the corresponding suitable salt of perchloric acid is generally added dropwise as an aqueous solution with a concentration of around 50 to around 70 wt.-%. The formed onium perchlorate can, provided it is insoluble in water, be separated as a precipitate by means of common separation methods, e.g. filtration or centrifugation.

The subject matter of the present invention is thus further a process for producing a stabilizer composition according to the invention, in which an organic compound which is capable of forming an onium salt, or a salt of such a compound, is combined with perchloric acid or with an inorganic salt of perchloric acid, the thus-formed onium salt of the organic compound is separated and dissolved in an organic solvent.

If the organic compound used for formation of an onium salt forms a water-insoluble organic perchlorate, as inorganic salt of perchloric acid is used an alkali perchlorate, e.g. sodium perchlorate or potassium perchlorate is reacted in aqueous solution with an onium perchlorate. In this way, a water-insoluble organic onium perchlorate and a water-soluble alkali chloride are formed. The water-insoluble organic onium perchlorate can be separated in common ways and then dissolved in an organic solvent. Optionally, in an intermediate step, water can be removed from the organic onium perchlorate.

If the organic compound used for formation of an onium salt forms a water soluble organic perchlorate, a compound which forms a water-insoluble chloride is used as inorganic salt of perchloric acid. The water-insoluble chloride can be separated. Then the soluble onium perchlorate can be freed of water using common methods.

As organic compound capable of forming an onium salt, in the scope of a further embodiment of the present invention a water soluble organic onium chloride, preferably silver perchlorate, is used an as inorganic salt of perchloric acid . If the water-soluble organic onium chloride is combined in aqueous solution with silver perchlorate, a precipitate forms of insoluble silver chloride and an aqueous solution forms of an organic onium perchlorate. The precipitate is then filtered and the organic onium perchlorate in the aqueous solution is isolated by means of common separation methods, e.g. by distilling the water.

The subject matter of the present invention is thus also a process for producing a stabilizer combination according to the invention, in which as organic compound capable of forming an onium salt an organic onium chloride is used, and as inorganic salt of perchloric acid an alkali perchlorate is used, wherein the organic onium chloride is combined with an aqueous solution of the alkali perchlorate, whereby a water-insoluble organic onium perchlorate and alkali chloride forms and the water-insoluble organic onium perchlorate is separated.

The production of an onium perchlorate and of a stabilizer composition according to the invention is not only carried out in aqueous solution. It is also possible to produce a corresponding onium perchlorate in organic solution.

To this end, an organic solution of an organic compound capable of forming an onium salt or a salt of such a compound is combined with aqueous perchloric acid or with an aqueous solution of an inorganic salt of perchloric acid. In this way an organic onium perchlorate forms, which remains in the organic solution. It is thus also possible to work in organic solvents, which are not miscible with water, as well as in organic solvents which are water-miscible. The water is then removed from the mixture.

The subject matter of the present invention is thus also a process for producing a stabilizer composition according to the invention, in which an organic solution of an organic compound capable of forming an onium salt, or a salt of such a compound, is combined with aqueous perchloric acid or with an aqueous solution of an inorganic salt of perchloric acid, whereby a solution of an organic onium perchlorate is formed.

A stabilizer composition according to the invention can, as is seen, e.g. from the described processes, comprise as solvent in principle any suitable compound. As a particular case, which should here receive particular mention, a stabilizer composition according to the invention can comprise as solvent or as component of the solvent a compound which can serve as basis for producing an onium perchlorate, in particular as basis for producing an onium perchlorate contained in a stabilizer composition according to the invention.

A stabilizer composition according to the invention can, besides the above-described obligatory compounds (onium perchlorate, or onium perchlorate and at least one organic solvent) comprise one or more further additives in an above-mentioned quantity.

In the following, in the scope of the present text, additives are listed, which in principle are suited for use in a stabilizer composition according to the invention alone or as a mixture of two or more thereof.

In the scope of the present invention the aminouracil compounds of general formula II are suitable as additives 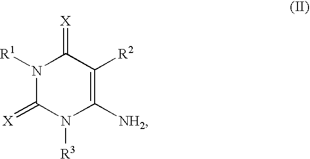
whereby the residues R¹ and R² respectively independently of each other stand for hydrogen, an optionally substituted linear or branched, saturated or unsaturated aliphatic alkyl residue with 1 to 44 C-atoms, an optionally substituted saturated or unsaturated cycloalkyl residue with 6 to 44 C-atoms or an optionally substituted aryl residue with 6 to 44 C-atoms or an optionally substituted aralkyl residue with 7 to 44 C-atoms, or the residue R¹ stands for an optionally substituted acyl residue with 2 to 44 C-atoms, and the residue R³ stands for hydrogen, an optionally substituted linear or branched, saturated or unsaturated, aliphatic hydrocarbon residue with 1 to 44 C-atoms, an optionally substituted, saturated or unsaturated cycloaliphatic hydrocarbon residue with 6 to 44 C-atoms, or an optionally substituted aromatic hydrocarbon residue with 6 to 44 C-atoms.

Further suited as additives are, in general, compounds with a structure element of general formula III 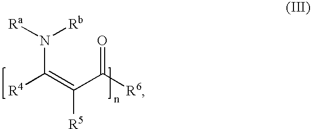
wherein n stands for a number from 1 to 100,000; the residues R^{a}, R^{b}, R⁴ and R⁵ respectively independently of each other stand for hydrogen, an optionally substituted, linear or branched, saturated or unsaturated, aliphatic alkyl residue with 1 to 44 C-atoms, an optionally substituted saturated or unsaturated cycloalkyl residue with 6 to 44 C-atoms, or an optionally substituted aryl residue with 6 to 44 C-atoms, or an optionally substituted aralkyl residue with 7 to 44 C-atoms; or the residue R⁴ stands for an optionally substituted acyl residue with 2 to 44 C-atoms; or the residues R⁴ and R⁵ are connected to an aromatic or heterocyclic system; and wherein the residue R⁶ stands for hydrogen, an optionally substituted, linear or branched, saturated or unsaturated aliphatic alkyl or alkylene residue, or oxyalkyl or oxyalkylene residue, or mercaptoalkyl or mercaptoalkylene residue, or aminoalkyl or aminoalkylene residue with 1 to 44 C-atoms, or an optionally substituted saturated or unsaturated cycloalkyl or cycloalkylene residue, or oxycycloalkyl or oxycycloalkylene residue, or mercaptocycloalkyl or mercaptocycloalkylene residue, or aminocycloalkyl or aminocycloalkylene residue with 6 to 44 C-atoms, or an optionally substituted aryl or arylene residue with 6 to 44 C-atoms, or an ether or thioether residue with 1 to 20 O- or S-atoms or O- and S-atoms, or for a polymer which is linked via O, S, NH, NR^{a} or CH₂C(O) with the structure element in parenthesis; or the residue R⁶ is connected to residue R⁴ in such a way that altogether an optionally substituted, saturated or unsaturated heterocyclic ring system with 4 to 24 C-atoms is formed.

A preferred embodiment of the present invention using a compound of general formula 1, includes a compounds based on a α,β-unsaturated β-aminocarboxylic acid, in particular on β-aminocrotonic acid. Particularly suited here are the esters or thioesters of the corresponding aminocarboxylic acids with mono- or polyprotic alcohols or mercaptans, whereby X in the cases mentioned stands respectively for O or S.

If the residue R⁶ stands, together with X, for an alcohol or mercaptan residue, a residue of, e.g., methanol, ethanol, propanol, isopropanol, butanol, 2-ethylhexanol, isooctanol, isononanol, decanol, lauryl alcohol, myristyl alcohol, palmityl alcohol, stearyl alcohol, ethyleneglycol, propyleneglycol, 1,3-butanediol, 1,4-butanediol, 1,6-hexanediol, 1,10-decanediol, diethyleneglycol, thio-diethanol, trimethylolpropane, glycerine, tris-(2-hydroxymethyl)-isocyanurate, triethanolamine, pentaerythritol, di-trimethylolpropane, diglycerine, sorbitol, mannitol, xylitol, di-pentaerythritol as well as the corresponding mercapto derivatives of the named alcohols, can be formed.

A particularly preferred embodiment of the present invention using a compound of general formula III includes compounds in which R⁴ stands for a linear alkyl residue with 1 to 4 C-atoms, R⁵ stands for hydrogen, and R⁶ stands for a linear or branched, saturated, 1- to 6-valent alkyl or alkylene residue with 2 to 12 C-atoms or a linear, branched or cyclic 2- to 6-valent ether alcohol residue or thioether alcohol residue.

Suitable compounds of general formula III comprise, e.g., β-aminocrotonic acid stearylester, 1,4-butanediol-di(β-aminocrotonic acid) ester, thio-diethanol-β-aminocrotonic acid ester, trimethylolpropane-tri-β-aminocrotonic acid ester, pentaerythritol-tetra-β-aminocrotonic acid ester, dipentaerythritol-hexa-β-aminocrotonic acid ester and the like. The compounds mentioned can be included in a stabilizer composition according to the invention respectively alone or as a mixture of two or more thereof.

Likewise suitable as compounds of general formula IlIl are, e.g. compounds in which the residues R⁴ and R⁵ are linked to an aromatic or hetero aromatic system, e.g. aminobenzoic acid, aminosalicylic acid or aminopyridincarboxylic acid and suitable derivatives thereof.

Suitable further additives include, e.g., compounds which have a mercapto-functional sp²-hybridised C-atom, carbazoles, carbazole derivatives or 2,4-pyrrolidinedione or 2,4-pyrrolidinedione-derivatives.

Suitable compounds which have at least one mercaptofunctional, sp²-hybridised C-atom in the scope of the present invention include in principle all compounds which have a structure element Z=CZ-SH or a structure element Z₂C=S, whereby both structure elements can be tautomeric forms of a single compound. The sp²-hybridised C-atom can thus be a component of an optionally substituted aliphatic compound or a component of an aromatic system. Suitable compound types are e.g. thiocarbamic acid derivatives, thiocarbamates, thiocarboxylic acids, thiobenzoic acid derivatives, thioacetone derivatives or thiourea or thiourea derivatives.

A further embodiment of the present invention uses an additive with at least one mercaptofunctional, sp²-hybridised C-atom thiourea or a thioureaderivative.

Likewise suitable as additive are, e.g., epoxy compounds. Examples of epoxy compounds of this type are epoxidised soja oil, epoxidised olive oil, epoxidised linseed oil, epoxidised castor oil, epoxidised peanut oil, epoxidised maize oil, epoxidised cottonseed oil, as well as glycidyl compounds.

Particularly suitable epoxy compounds are, e.g., described in EP-A 1 046 668 on pages 3 to 5, which is hereby incorporated by reference.

Further suited as additives in the scope of the present invention are 1,3-dicarbonyl compounds, in particular β-diketones and β-ketoesters. In the scope of the present invention are suitable dicarbonyl compounds of general formula R′C(O)CHR″-C(O)R′″, as, e.g., described on p. 5 of EP-A 1 046 668, which are explicitly referred to, in particular with respect to the residues R′, R″ and R′″ and the disclosure of which is incorporated by reference and considered as a part of the disclosure of the present text. Particularly suitable are thus e.g. acetylacetone, butanoylacetone, heptanoylacetone, stearoylacetone, palmitoylacetone, lauroylacetone, 7-tert-nonylthioheptanedione-2,4, benzoylacetone, dibenzoylmethane, lauroylbenzoylmethane, palmitoylbenzoylmethane, stearoylbenzoylmethane, isooctylbenzoylmethane, 5-hydroxycapronylbenzoylmethane, tribenzoylmethane, bis(4-methylbenzoyl)methane, benzoyl-p-chlorobenzoylmethane, bis(2-hydroxybenzoyl)methane, 4-methoxybenzoylbenzoylmethane, bis(4-methoxybenzoyl)methane, benzoylformylmethane, benzoylacetylphenylmethane, 1-benzoyl-1-acetyinonane, stearoyl-4-methoxybenzoylmethane, bis(4-tert-butylbenzoyl)methane, benzoylphenylacetylmethane, bis(cyclohexanoyl)methane, dipivaloylmethane, 2-acetylcyclopentanone, 2-benzoylcyclopentanone, diacetic acid methyl-, ethyl-, butyl-, 2-ethylhexyl-, dodecyl- or octadecylester as well as propionyl- or butyrylacetic acid esters with 1 to 18 C-atoms as well as stearoylacetic acid ethyl-, propyl-, butyl-, hexyl- or octylester or polynuclear fl-ketoesters as described in EP-A 433 230, which is incorporated by reference, or dehydroacetic acids such as zinc-, magnesium- or alkali salts of the alkali, alkaline earth or zinc chelates of the named compounds, provided that these exist and or, in the stabilizer compositions according to the invention, soluble or miscible with these to achieve the above-mentioned results.

1,3-diketo-compounds can be contained in a stabilizer composition according to the invention in a quantity of up to about 20 wt.-%, e.g. up to about 10 wt.-%.

Further suited as additives in the scope of the stabilizer composition of the present invention are polyols. Suitable polyols are e.g. pentaerythritol, dipentaerythritol, tripentaerythritol, bistrimethylolpropan, Inositol, polyvinylalcohol, bistrimethylolethan, trimethylolpropan, sorbite, maltitol, isomaltitol, lactitol, lycasine, mannitol, lactose, leucrose, tris-(hydroxymethyl)isocyanurate, palatinite, tetramethylolcyclohexanol, tetramethylolcyclopentanol, tetramethylolcycloheptanol, glycerine, diglycerine, polyglycerine, thiodiglycerine or 1-0-a-D-glycopyranosyl-D-mannitol-dihydrate.

The polyols suitable as additives can be included in a stabilizer composition according to the invention in a quantity of up to around 30 wt.-%, e.g. up to around 10wt.-%.

Likewise suitable as additives are, e.g., sterically hindered amines as mentioned in EP-A 1 046 668 on pages 7 to 27, which is hereby incorporated by reference. Reference is explicitly made to the therein-disclosed sterically hindered amines, the therein-mentioned compounds are considered as a part of the disclosure of the present text.

These sterically hindered amines suitable as additives can be included in a stabilizer composition according to the invention in a quantity of up to around 30 wt.-%, e.g., up to around 10 wt.-%.

A stabilizer composition according to the invention can furthermore comprise as additive an organotin compound or a mixture of two or more organotin compounds. Suitable organotin compounds are e.g. methyltin-tris-(isooctyl-thioglycolate), methyltin-tris-(isooctyl-3-mercaptopropionate), methyltin-tris-(isodecyl-thioglycolate), dimethyltin-bis-(isooctyl-thioglycolate), dibutyltin-bis-(isooctyl-thioglycolate), monobutyltin-tris-(isooctyl-thioglycolate), dioctyltin-bis-(isooctyl-thioglycolate), monooctylti n-tris-(isooctyl-thioglycolate) or dimethyltin-bis-(2-ethyl hexyl-β-mercaptopropionate).

Furthermore, in the scope of the stabilizer compositions according to the invention, the organotin compounds mentioned in EP-A 0 742 259 on pages 18 to 29 and described in their production can be used. The above-mentioned disclosure is hereby incorporated by reference, whereby the compounds mentioned therein and their production are understood to be a part of the disclosure of the present text.

A stabilizer composition according to the invention can comprise the described organotin compounds in a quantity of up to around 40 wt.-%, in particular up to around 20 wt.-%.

In the scope of a further embodiment of the present invention a stabilizer composition according to the invention can comprise organic phosphite esters with 1 to 3 identical, pairwise identical or different organic residues. Suitable organic residues are, e.g. linear or branched, saturated or unsaturated alkyl residues with 1 to 24 C-atoms, optionally substituted alkyl residues with 6 to 20 C-atoms or optionally substituted aralkyl residues with 7 to 20 C-atoms. Examples of suitable organic phosphite esters are tris-(nonylphenyl)-, trilauryl-, tributyl-, trioctyl-, tridecyl-, tridodecyl-, triphenyl-, octyldiphenyl-, dioctylphenyl-, tri-(octylphenyl)-, tribenzyl-, butyldicresyl-, octyl-di(octylphenyl)-, tris-(2-ethylhexyl)-, tritolyl-, tris-(2-cyclohexylphenyl)-, tri-α-naphthyl-, tris-(phenylphenyl)-, tris-(2-phenylethyl)-, tris-(dimethylphenyl)-, tricresyl- or tris-(p-nonylphenyl)-phosphite or tristearyl-sorbit-triphosphite or mixtures of two or more thereof.

A stabilizer composition according to the invention can comprise the described phosphite compounds in a quantity of up to around 30 wt.-% in particular up to around 10 wt.-%.

A stabilizer composition according to the invention can furthermore comprise as additive blocked mercaptans, as mentioned in EP-A 0 742 259 on pages 4 to 18, which is hereby incorporated by reference.

A stabilizer composition according to the invention can comprise the described blocked mercaptans in a quantity of up to around 30 wt.-%, in particular up to around 10 wt.-%.

A stabilizer composition according to the invention can further comprise lubricants (“Gleitmittel”) such as montan wax, fatty acid esters, purified or hydrated natural or synthetic triglycerides or partial esters, polyethylene waxes, amide waxes, chloroparaffins, glycerine esters or alkaline earth soaps, provided that these lubricants do not fall under the term “solvent” in the sense of the present text. Lubricants which can be used as additives are further described also in “Kunststoffadditive”, R. Gaichter/H. Muller, Carl Hanser Verlag, 3rd edition, 1989, p. 478-488. Further suited as additives are, e.g., fatty ketones as are described in DE 42 04 887 as well as lubricants based on silicon, as e.g. named in EP-A 0 259 783, or combinations thereof, as are mentioned in EP-A 0 259 783. The above mentioned documents are hereby incorporated by reference, and their disclosure concerning lubricants is considered as part of the disclosure of the present text.

A stabilizer composition according to the invention can comprise the described lubricants in a quantity of up to around 70 wt.-%, in particular up to around 40 wt.-%.

Likewise suitable as additives for stabilizer compositions according to the present invention are organic softeners, provided that these softeners do not already fall under the term “solvent” in the sense of the present text.

As corresponding softeners are suitable, e.g., the compounds mentioned in the scope of the description of the solvent from the group of phthalic acid esters such as dimethyl-, diethyl-, dibutyl-, dihexyl-, di-2-ethylhexyl-, di-n-octyl-, di-iso-octyl-, di-iso-nonyl-, di-iso-decyl-, dicyclohexyl-, di-methylcyclohexyl-, dimethylglycol-, dibutylglycol-, benzylbutyl- or diphenylphthalate as well as mixtures of phthalates, e.g. mixtures of alkylphthalates with 7 to 9 or 9 to 11 C-atoms in the ester alcohol or mixtures of alkyl phthalates with 6 to 10 and 8 to 10 C-atoms in the ester alcohol. Particularly suited in the sense of the present invention are thus dibutyl-, dihexyl-, di-2-ethylhexyl-, di-n-octyl-, di-iso-octyl-, di-iso-nonyl-, di-iso-decyl-, di-iso-tridecyl- and benzylbutylphthalate, as well as the mentioned mixtures of alkyl phthalates.

Further suited as softeners are the esters of aliphatic dicarboxylic acids, in particular the esters of adipinic, azelaic or sebacic acids or mixtures of two or more thereof. Examples of softeners of this type are di-2-ethylhexyladipate, di-isooctyladipate, di-iso-nonyladipate, di-iso-decyladipate, benzylbutyladipate, benzyloctyladipate, di-2-ethylhexylazelate, di-2-ethylhexylsebacate and di-iso-decylsebacate. Preferred in the context of a further embodiment of the present invention are di-2-ethylhexylacetate and di-iso-octyladipate.

Also suitable as softener are trimellitic acid esters such as tri-2-ethylhexyl-trimellitate, tri-iso-tridecyltrimellitate, and tri-iso-octyltrimellitate as well as trimellitic acid esters with 6 to 8, 6 to 10, 7 to 9 or 9 to 11 C-atoms in the ester groups or mixtures of two or more of the mentioned compounds.

Further suited softeners are, e.g., polymer softeners, as given in “Kunststoffadditive”, R. Gachter/H. Muller, Carl Hanser Verlag, 3rd edition, 1989, chapter 5.9.6, pages 412-415, or “PVC Technology”, W. V. Titow, 4^{th} edition, Elsevier Publishers, 1984, pages 165-170. The most common starting materials for the production of polyester softeners are e.g. dicarboxylic acids such as adipinic, phthalic, azelaic or sebacic acids as well as diols such as 1,2-propandiol, 1,3-butanediol, 1,4-butanediol, 1,6-hexanediol, neopentylglycol or diethyleneglycol or mixtures of two or more thereof.

Also suitable as softeners are phosphoric acid esters, as can be found in “Taschenbuch der Kunststoffadditive”, chapter 5.9.5, p. 408-412. Examples of suitable phosphoric acid esters are tributylphosphate, tri-2-ethylbutylphosphate, tri-2-ethylhexylphosphate, trichlorethylphosphate, 2-ethyl-hexyl-di-phenylphosphate, triphenylphosphate, tricresylphosphate or trixylenylphosphate or mixtures of two or more thereof.

Further suited as softeners are chlorinated hydrocarbons (paraffins) or hydrocarbons as described in “Kunststoffadditive”, R. Gatchter/H. MUller, Carl Hanser Verlag, 3rd edition, 1989, chapter 5.9.14.2, p.422-425 and chapter 5.9.14.1, p. 422.

A stabilizer composition according to the invention can comprise the described softeners in a quantity of up to around 99.5 wt.-%, in particular up to around 30 wt.-%, up to around 20 wt.-% or up to around 10 wt.-%. In the scope of a preferred embodiment of the present invention the lower limit for the described softeners as component of the stabilizer composition according to the invention amounts to around 0.1 wt.-% or more, e.g. around 0.5 wt.-%, 1 wt.-%, 2 wt.-% or 5 wt.-%.

In the scope of a further embodiment of the present invention the stabilizer composition according to the invention can comprise anti-oxidants, UV-absorbers or light-screening agents. Suitable anti-oxidants are e.g. described in EP-A 1 046 668 on pages 33 to 35, which is incorporated herein by reference. Suitable UV-absorber and light-screening agents are mentioned there on pages 35 to 36, which is also incorporated herein by reference. As such, these disclosures are considered as part of the present text.

A stabilizer composition according to the invention can, besides a polymer and a stabilizer composition according to the invention, also comprise further additives which are not soluble in the stabilizer composition according to the invention. Suitable, in principle, are all additives, e.g. those which do not or insubstantially influence the transparency of a polymer composition produced using such a stabilizer composition.

Further suited as additives in the stabilizer compositions according to the invention are hydrotalcites, hydrocalumites, zeolites and alkalialumocarbonates. Suitable hydrotalcites, hydrocalumites, zeolites and alkalialumocarbonates are e.g. described in EP-A 1 046 668 on pages 27 to 29, EP-A 256 872 on pages 3, 5 and 7, DE-C 41 06 411 on pages 2 and 3 or DE-C 41 06 404 on pages 2 and 3 or DE-C 198 60 798. These documents are hereby incorporated by reference and the disclosure in these documents is considered as part of the disclosure of the present text.

The hydrotalcites, hydrocalumites, zeolites and alkalialumocarbonates suitable as additives can be comprised in a stabilizer composition according to the invention in a quantity of up to around 50 wt.-%, e.g. from 0 to around 30 wt.-%.

Also suited as additives in the stabilizer compositions according to the invention are metal oxides, metal hydroxides and metal soaps of saturated, unsaturated, straight-chain or branched, aromatic, cycloaliphatic or aliphatic carboxylic acids or hydroxycarboxylic acids with preferably around 2 to around 22 C-atoms.

As metal cations, the metal oxides, metal hydroxides or metal soaps suitable as additives have preferably a divalent cation, particularly suitable are the cations of calcium or zinc or mixtures thereof.

Examples of suitable carboxylic acid anions comprise anions of monovalent carboxylic acids such as acetic acid, propionic acid, butyric acid, valeric acid, hexanoic acid, oenanthic acid, octanoic acid, neodecanoic acid, 2-ethylhexanoic acid, pelargonic acid, decanoic acid, undecanoic acid, dodecanoic acid, tridecanoic acid, myristinic acid, palmitic acid, lauric acid, isostearic acid, stearic acid, 12-hydroxystearic acid, 9,10-dihydroxystearic acid, oleic acid, 3,6-dioxaheptanoic acid, 3,6,9-trioxadecanoic acid, behenic acid, benzoic acid, p-tert-butylbenzoic acid, di-methylhydroxybenzoic acid, 3,5-di-tert-butyl-4-hydroxybenzoic acid, toluic acid, dimethyl-benzoic acid, ethylbenzoic acid, n-propylbenzoic acid, salicylic acid, p-tert-octylsalicylic acid, sorbinic acid, anions of divalent carboxylic acids or respectively monoesters thereof such as oxalic acid, malonic acid, maleic acid, tartaric acid, cinnamic acid, amygdalic acid, malic acid, glycolic acid, oxalic acid, salicylic acid, polyglycoldicarboxylic acids with a degree of polymerisation of around 10 to around 12, phthalic acid, isophthalic acid, terephthalic acid or hydroxyphthalic acid, anions of tri- or tetravalent carboxylic acid or respectively mono-, di- or triesters thereof such as in hemimellitic acid, trimellitic acid, pyromellitic acid or citric acid as well as so-called overbasic carboxylates as e.g. described in DE-A 41 06 404 or DE-A 40 02 988, which are hereby incorporated by reference.

In the scope of a preferred embodiment of the present invention preferably metal soaps are used, whose anions are derived from saturated or unsaturated carboxylic acids or hydroxycarboxylic acids with around 8 to around 20 C-atoms. Particularly preferred are thus stearates, oleates, laurates, palmitates, behenates, versatates, hydroxystearates, dihydroxystearates, p-tert-butylbenzoates or (iso)octanoates of calcium or zinc or mixtures of two or more thereof. In the scope of a further preferred embodiment of the present invention a polymer composition according to the invention comprises calcium stearate or zinc stearate or mixtures thereof.

A stabilizer composition according to the invention can comprise the mentioned metal oxides, metal hydroxides or metal soaps or a mixture of two or more thereof in a quantity of up to around 50 wt.-%, e.g., in a quantity of up to around 30 wt.-%.

A stabilizer composition according to the invention can further comprise filling agents as described in the “Handbook of PVC Formulating”, E. J. Wickson, John Wiley & Sons, Inc., 1993, on pages 393-449 or strengthening agents as described in the “Taschenbuch der Kunststoffadditive”, R. Gatchter/H. Muller, Carl Hanser Verlag, 1990, pages 549-615, or pigments.

A stabilizer composition according to the invention can furthermore comprise impact resistance modifiers and processing aids, gelling agents, antistatic agents, biocides, metal deactivators, optical brighteners, flame retardant agents as well as anti-fogging compounds. Suitable compounds of this class of compounds are e.g. in “Kunststoff Additive ”, R. Gächter/H. MUller, Carl Hanser Verlag, 3rd edition, 1989 as well as in the “Handbook of PVC Formulating”, E. J. Wilson, J. Wiley & Sons, 1993.

In the scope of the present invention it has been found that the onium salts of perchlorates are suitable for stabilizing halogen-containing organic polymers. The subject matter of the present invention is thus a polymer composition comprising at least one halogen-containing organic polymer and an onium salt of a perchlorate. The quantities of onium salt to be used correspond to the quantities described in the scope of the further text for the stabilizer composition according to the invention.

Examples of halogen-containing polymers of this type are polymers of vinyl chlorides, vinyl resins which comprise vinyl chloride units in the polymer backbone, copolymers of vinyl chloride and vinyl esters of aliphatic acids, in particular vinyl acetate, copolymers of vinyl chloride with esters of acrylic and methacrylic acid or acrylonitrile or mixtures of two or more thereof, copolymers of vinyl chloride with diene compounds or unsaturated dicarboxylic acids or anhydrides thereof, e.g. copolymers of vinyl chloride with diethylmaleate, diethylfumarate or maleic acid anhydride, post-chlorinated polymers and copolymers of vinyl chloride, copolymers of vinyl chloride and vinylidene chloride with unsaturated aldehydes, ketones and other compounds such as acrolein, crotonaldehyde, vinylmethylketone, vinylmethylether, vinylisobutylether and the like, polymers and copolymers of vinylidene chloride with vinylchloride and other polymerisable compounds, as already mentioned above, polymers of vinyl chloroacetate and dichlorodivinyl ether, chlorinated polymers of vinylacetate, chlorinated polymer esters of acrylic acid and α-substituted acrylic acids, chlorinated polystyrenes, for example polydichlorostyrene, chlorinated polymers of ethylene, polymers and post-chlorinated polymers of chlorobutadiene and their copolymers with vinyl chloride as well as mixtures of two or more of the mentioned polymers of polymer mixtures, which comprise one or more of the above-mentioned polymers.

Likewise suitable for stabilizing with the stabilizer compositions according to the invention are the graft polymers of PVC with EVA, ABS or MBS. Preferred substrates for graft copolymers of this type are additionally the previously mentioned homo- and copolymers, in particular mixtures of vinyl chloride homo polymers with other thermoplastic or elastomeric polymers, in particular blends with ABS, MBS, NBR, SAN, EVA, CPE, MBAS, PAA (polyalkylacrylate), PAMA (polyalkylmethacrylate), EPDM, polyamides or polylactones.

Also suited to stabilizing with the stabilizer compositions according to the invention are mixtures of halogenated and non-halogenated polymers, e.g., mixtures of the above-mentioned non-halogenated polymers with PVC, in particular mixtures of polyurethanes and PVC.

Furthermore, recyclates of chlorine-containing polymers can be stabilized with the stabilizer composition according to the invention, whereby in principle all recyclates of the above-mentioned, halogenated polymers are suitable therefore. In the scope of the present invention, e.g. PVC-recyclate is suitable.

A further subject matter of the present invention thus relates to a polymer composition comprising at least one halogenated polymer and a stabilizer composition according to the invention.

In the scope of a preferred embodiment of the present invention, a polymer composition according to the invention comprises the stabilizer composition according to the invention in a quantity of 0.1 to 20 phr, in particular around 0.5 to around 15 phr or around 1 to around 12 phr. The unit phr stands for “per hundred resin” and thus relates to parts by weight per 100 parts by weight of polymer.

Preferably, a polymer composition according to the invention comprises as halogenated polymer at least partially PVC, whereby the PVC fraction amounts in particular to at least around 20 wt.-%, preferably at least around 50 wt.-%, e.g., at least around 80 or at least around 90 wt.-%.

The present invention also relates to a process for stabilizing halogen-containing polymers, in which a halogen-containing polymer or a mixture of two or more halogen-containing polymers or a mixture of one or more halogen-containing polymer and one or more halogen-free polymers is mixed with a stabilizer composition according to the invention.

The mixing of polymer or polymers and the stabilizer composition according to the invention can in principle occur at any time before or during the processing of the polymer. Thus the stabilizer composition can, e.g., be mixed into the polymer which is present in powder or granulate form before processing. It is, however, likewise possible to add the stabilizer composition to the polymer or to the polymers in softened or melted state, e.g., during processing in an extruder.

A polymer composition according to the invention can be brought in known ways into a desired form. Suitable processes are, e.g., calendaring, extruding, injection molding, sintering, extrusion-blowing, or the plastisol process. A polymer composition according to the invention can, e.g., also be used in the production of foam materials. In principle the polymer composition according to the invention is suited to the production of hard or in particular soft PVC.

A polymer composition according to the invention can be processed into formed bodies. The subject matter of the present invention is therefore also formed bodies, at least comprising a stabilizer composition according to the invention or a polymer composition according to the invention.

The term “formed bodies” comprises, in the scope of the present invention, in principle all three dimensional structures which can be produced from a polymer composition according to the invention. The term “formed body” comprises, in the scope of the present invention, e.g., wire sheathing, automobile components, e.g., automobile components as are used in the interior of the automobile, in the motor space or at the outer areas, cable isolations, decoration films, agrofoil, tubes, sealing profiles, office films, hollow bodies (bottles), packing films (dep-drawing films), blow films, pipes, foam materials, heavy-duty profiles (window frames), light sheet profiles, building profiles, sidings, fittings, plates, foam plates, coextrudates with recycled core or housing for electrical apparatus or machines, e.g., computers or household appliances. Further examples of formed bodies producible from a polymer composition according to the invention are artificial leather, floor coverings, textile coatings, wall papers, coil-coatings or underfloor protection for motor vehicles.

The subject matter of the present invention is also the use of a stabilizer composition according to one of claims 1 to 4 or a stabilizer composition produced according to one of claims 5 to 8 or a polymer composition according to one of claims 9 or 10 in the production of polymer formed bodies or surface coating agents.

The invention is in the following more closely illustrated by means of examples.

### Production of the Perchlorate-Onium Salt

### EXAMPLE 1

15.11 g nicotinic acid ethyl ester (2-ethylcarboxypyridine) was suspended in 100 ml water and 16.73 g of a 60% aqueous HClO₄-solution was added dropwise. After 20 minutes of stirring a clear solution had formed. After removal of the water under vacuum, crystalline 2-ethylcarboxypyridinium perchlorate was obtained. In further experiments the product was used as a 10% solution (based on perchlorate) in propylenecarbonate.

### EXAMPLE 2

To a solution of 4.5 g formamide in 100 ml water were added dropwise with stirring 16.73 g of a 60% aqueous HClO₄-solution. After 20 minutes reaction time, the water was removed under vacuum. In this way crystalline formamidinium perchlorate was obtained. In further experiments this was used as a 10% solution (based on perchlorate) in formamide.

### EXAMPLE 3

To a solution of 3.39 g tetra-n-butylphosphonium bromide in 50 ml water were added dropwise, slowly, 1.6 g 60 wt.-% HClO₄ with vigorous stirring. After a few minutes the formation of a crystalline precipitate was observed. After filtration, 3.55 g tetra-n-butylphosphonium perchlorate was isolated. In further experiments the product was used as a 10% solution (based on perchlorate) in dioctylphthalate (DOP).

### EXAMPLE 4

22 g trimethylsulfoxonium iodide was dissolved in 300 ml water at room temperature. To this solution was added slowly, dropwise, with stirring, 16.74 g HClO₄ (60%). The trimethylsulfoxonium perchlorate could be isolated quantitatively by careful evaporation under vacuum. In the further experiments a solution in DOP (10% based on perchlorate) was used.

### EXAMPLE 5

To a solution of 26.05 g trishydroxyethylisocyanurate in dibutyloxalate were added, dropwise, with stirring, 16.66 g of a 60% aqueous HClO₄ solution. The obtained 10% solution was dehydrated under vacuum and used in further experiments as obtained.

### EXAMPLE 6

To a suspension of 11.72 g 2-(diethylamino)-ethanol in water were added dropwise, with stirring, 16.73 g 60% aqueous HClO₄. By evaporation under vacuum, the corresponding perchlorate salt was isolated quantitatively. The obtained product was used as a 10% solution based on perchlorate in epoxidised soy bean oil.

### EXAMPLE 7a

To a solution of 13.12 9 N-(2-hydroxyethyl)-morpholine in 100 ml water were added dropwise, with stirring, 16.73 g aqueous 60% HClO₄. By removal of water under vacuum the corresponding N-(2-hydroxyethyl)-morpholinium perchlorate was obtained quantitatively. In further experiments, by dissolving 2.3 g of the obtained product in N-(2-hydroxyethyl)-morpholine, a 10% solution based on perchlorate was obtained. This was used in the further experiments.

### EXAMPLE 7b

To 45 g N-(2-hydroxyethyl)-morpholine were added dropwise, with stirring, 8.37 aqueous 60% HClO₄. By removal of water under vacuum the corresponding N-(2-hydroxyethyl)-morpholinium perchlorate was obtained quantitatively in the form of a 10% solution in N-(2-hydroxyethyl)-morpholine and used in the following.

### EXAMPLE 8a

To a solution of 35.36 g trioctylamine in 100 ml water were added dropwise, with stirring, 16.73 g aqueous 60% HClO₄. By removal of water under vacuum the corresponding trioctylammonium perchlorate was obtained quantitatively. In the further procedure, a 10% solution, based on perchlorate, was obtained by dissolving 4.5 g of the obtained product in DOP. This was used in the further experiments.

### EXAMPLE 8b

To a mixture of 17.68 g trioctylamine and 27.5 9 DOP were added dropwise with stirring 8.37 g aqueous 60% HClO₄. By removal of the water under vacuum the corresponding trioctylammonium perchlorate was obtained quantitatively in the form of a 10% solution in DOP and used in the further experiments.

TABLE 1

| Component | Trade or trivial name | V1 | V2 | V3 | E1 | E2 | E3 | E4 | E5 |
|---|---|---|---|---|---|---|---|---|---|
| PVC | | 100 | 100 | 100 | 100 | 100 | 100 | 100 | 100 |
| softener | DOP | 60 | 60 | 60 | 60 | 60 | 60 | 60 | 60 |
| epoxidised soy oil | | 3 | 3 | 3 | 3 | 3 | 3 | 3 | 3 |
| acid trap | Calcium hydroxide | 0.4 | 0.4 | 0.4 | 0.4 | 0.4 | 0.4 | 0.4 | 0.4 |
| calcium stearate | BS ceasit SW | 0.3 | 0.3 | 0.3 | 0.3 | 0.3 | 0.3 | 0.3 | 0.3 |
| butyleneglycol-bis-aminocrotonate | | 0.2 | 0.2 | 0.2 | 0.2 | 0.2 | 0.2 | 0.2 | 0.2 |
| co-stabilizer | Mercaptobenzimidazol | 0.1 | 0.1 | 0.1 | 0.1 | 0.1 | 0.1 | 0.1 | 0.1 |
| perchlorate-containing co-stabilizer, | | | 0.15 | | | | | | |
| perchlorate-containing co-stabilizer, | Mark CE 530 | | | 0.05 | | | | | |
| liquid, commercially available | | | | | | | | | |
| according to example 1 (inventive) | | | | | 0.15 | | | | |
| according to example 2 (inventive) | | | | | | 0.15 | | | |
| according to example 4 (inventive) | | | | | | | 0.15 | | |
| according to example 5 (inventive) | | | | | | | | 0.15 | |
| according to example 7b (inventive) | | | | | | | | | 0.15 |
| Transparency | | 1 | 3 | 1 | 1 | 1 | 1 | 1 | 1 |
| HCl-stability (DIN VDE 0472 part | | 25 | 41 | 42 | 37 | 43 | 45 | 44 | 45 |
| Starting colour a-value | | −0.7 | −0.8 | −0.1 | −0.9 | −1.2 | −1.4 | −0.9 | −0.9 |
| Starting colour b-value | | 3.3 | 3.7 | 4 | 6.7 | 5.2 | 4.2 | 4.3 | 3.4 |
| Starting colour L-value | | 91.7 | 91.1 | 92.6 | 91 | 91.3 | 94.6 | 94.8 | 93.3 |
| Colour after 15 minutes, 200° C., a- | | 29.9 | 3 | 1.7 | −2.9 | −4.5 | −4.9 | −3.2 | −4.8 |
| Colour after 15 minutes, 200° C., b- | | 67.3 | 58.7 | 62.3 | 46 | 36.9 | 41.9 | 47.8 | 40.5 |
| Colour after 15 minutes, 200° C., L- | | 60.4 | 80.6 | 81.2 | 89.3 | 92.1 | 90 | 88.8 | 90.6 |

TABLE 2

| Component | Trade or trivial name | V4 | V5 | V6 | E6 | E7 | E8 | E9 |
|---|---|---|---|---|---|---|---|---|
| PVC | | 100 | 100 | 100 | 100 | 100 | 100 | 100 |
| filling agent | Chalk | 2 | 2 | 2 | 2 | 2 | 2 | 2 |
| hydrocalumite | BS EX 3061 | 0.6 | 0.6 | 0.6 | 0.6 | 0.6 | 0.6 | 0.6 |
| acid trap | calcium hydroxide | 0.2 | 0.2 | 0.2 | 0.2 | 0.2 | 0.2 | 0.2 |
| calcium stearate | | 0.6 | 0.6 | 0.6 | 0.6 | 0.6 | 0.6 | 0.6 |
| paraffin wax | BL LKT | 0.6 | 0.6 | 0.6 | 0.6 | 0.6 | 0.6 | 0.6 |
| polyethylene wax | BL PA | 0.5 | 0.5. | 0.5 | 0.5 | 0.5 | 0.5 | 0.5 |
| oxidised polyethylene wax | BL PA special | 0.1 | 0.1 | 0.1 | 0.1 | 0.1 | 0.1 | 0.1 |
| co-stabilizer | Butyleneglycolbisaminocrotonate | 0.3 | 0.3 | 0.3 | 0.3 | 0.3 | 0.3 | 0.3 |
| pigment | Titanium dioxide | 0.1 | 0.1 | 0.1 | 0.1 | 0.1 | 0.1 | 0.1 |
| NaClO₄-containing co-stabilizer, | | | 0.2 | | | | | |
| perchlorate-containing co- | Mark CE 530 | | | 0.06 | | | | |
| stabilizer, liquid | | | | | | | | |
| according to example 7a | | | | | 0.2 | | | |
| according to example 7b | | | | | | 0.2 | | |
| according to example 8a | | | | | | | 0.2 | |
| according to example 8b | | | | | | | | 0.2 |
| HCl-stability (DIN VDE 0472 part | | 22 | 21 | 22 | 22 | 22 | 22 | 22 |
| starting colour a-value | | −0.4 | −0.1 | 0.7 | −3.3 | −3.3 | −2.7 | −2.7 |
| starting colour b-value | | 33.6 | 38.2 | 39.5 | 27.8 | 27.8 | 28.5 | 28.6 |
| starting colour L-value | | 81.2 | 79.5 | 80.5 | 83.3 | 83.5 | 83 | 83.2 |
| colour after 15 minutes, 200° C., | | 27.3 | 25.9 | 18.1 | −0.9 | −0.5 | −0.1 | 1.3 |
| colour after 15 minutes, 200° C., | | 43.2 | 50 | 56 | 40.3 | 40.8 | 46 | 47.3 |
| colour after 15 minutes, 200° C., | | 54.7 | 59.3 | 69.7 | 86.2 | 85.9 | 85.1 | 84.2 |

1. A stabilizer composition comprising
at least one organic onium perchlorate and
at least one organic solvent, wherein the at least one organic onium perchlorate is present in a concentration of at least 0.05 % by weight, based on the total weight of the composition.

2. The stabilizer composition as claimed in claim 1, wherein the total concentration of the at least one organic onium perchlorate is from 0.1 to 20% by weight, based on the total weight of the composition.

3. The stabilizer composition as claimed in claim 1, wherein the at least one organic onium perchlorate includes a salt selected from the group consisting of ammonium perchlorates and sulfonium perchlorates.

4. The stabilizer composition as claimed in claim 1, wherein the at least one organic onium perchlorate includes at least one compound selected from the group consisting of tricycloalkylsulfonium perchlorates, triarylsulfonium perchlorates, and trialkylsulfonium perchlorates.

5. The stabilizer composition as claimed in claim 1, wherein the at least one organic onium perchlorate includes at least one compound selected from the group consisting of perchlorates of heterocyclic amino alcohols and perchlorates of alkylamines.

6. The stabilizer composition as claimed in claim 1, wherein the at least one organic onium perchlorate includes at least one perchlorate of heterocyclic amino alcohols selected from the group consisting perchlorates derived from heterocyclic amino alcohols having a structural formula of 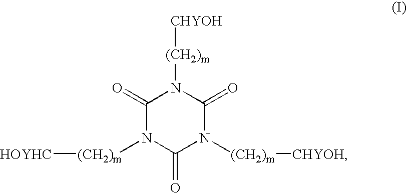
wherein m is from 0 to 20 and Y is selected from the group consisting of hydrogen and linear or branched, saturated or unsaturated alkyl groups with from one to 10 carbon atoms.

7. The stabilizer composition as claimed in claim 1, wherein the at least one organic onium perchlorate includes at least one perchlorate selected from the group consisting of tetra-n-butyl phosphonium perchlorate, triphenylbenzylphosphonium perchlorate, trimethylsulfoxonium perchlorate, 2-ethylcarboxypyridinium perchlorate, formamidinium perchlorate, perchlorate salt of tris-hydroxyethylisocyanurate, perchlorate salt of 2-(diethylamino)-ethanol, N-(2-hydroxyethyl)-morpholinium perchlorate, and trioctylammonium perchlorate.

8. The composition as claimed in claim 1, wherein the at least one organic solvent includes a solvent selected from the group consisting of phthalic acid esters, phthalates, esters of aliphatic dicarboxylic acids, trimellitic acid esters, and phosphoric acid esters.

9. A solid stabilizer composition comprising at least one organic onium perchlorate.

10. The stabilizer composition as claimed in claim 9, wherein the at least one organic onium perchlorate includes a perchlorate selected from the group consisting of ammonium perchlorates and sulfonium perchlorates.

11. The stabilizer composition as claimed in claim 9, wherein the at least one organic onium perchlorate includes at least one compound selected from the group consisting of tricycloalkylsulfonium perchlorates, triarylsulfonium perchlorates, and trialkylsulfonium perchlorates.

12. The stabilizer composition as claimed in claim 9, wherein the at is least one organic onium perchlorate includes at least one compound selected from the group consisting of perchlorates of heterocyclic amino alcohols and perchlorates of alkylamines.

13. The stabilizer composition as claimed in claim 9, wherein the at least one organic onium perchlorate includes at least one perchlorate of heterocyclic amino alcohols selected from the group consisting of perchlorates derived from heterocyclic amino alcohols having a structural formula of: 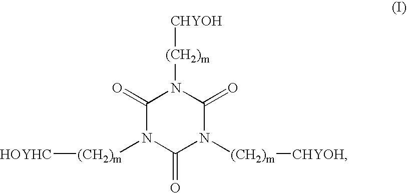
wherein m is from 0 to 20 and Y is selected from the group consisting of (a) hydrogen, and (b) linear or branched, saturated or unsaturated alkyl groups with one to approximately 10 carbon atoms.

14. The stabilizer composition as claimed in claim 9, wherein the at least one organic onium perchlorate includes at least one perchlorate selected from the group consisting of tetra-n-butyl phosphonium perchlorate, triphenylbenzylphosphonium perchlorate, trimethylsulfoxonium perchlorate, 2-ethylcarboxypyridinium perchlorate, formamidinium perchlorate, perchlorate salt of tris-hydroxyethylisocyanurate, perchlorate salt of 2-(diethylamino)-ethanol, N-(2-hydroxyethyl)-morpholinium perchlorate, and trioctylammonium perchlorate.

15. A stabilizer composition comprising at least one organic phosphonium perchlorate.

16. The stabilizer composition as claimed in claim 15, wherein the at least one organic phosphonium perchlorate includes at least one compound selected from the group consisting of tetraalkylphosphonium perchlorates, tetracycloalkylphosphonium perchlorates, and tetraarylphosphonium perchlorates.

17. The stabilizer composition as claimed in claim 15, wherein the at least one organic phosphonium perchlorate is selected from the group consisting of tetra-n-butylphosphonium perchlorate and triphenylbenzylphosphonium perchlorate.

18. A process for producing a stabilizer composition comprising dissolving at least one organic onium perchlorate in at least one organic solvent.

19. The process as claimed in claim 18 wherein the at least one organic onium perchlorate is a phosphonium perchlorate.

20. A process for producing a stabilizer composition comprising
(i) reacting
(1) at least one organic compound selected from the group consisting of organic onium salts and organic compounds capable of forming an onium salt with
(2) at least one perchlorate compound selected from the group consisting of perchloric acid and inorganic salts of perchloric acid,
to form an onium perchlorate salt;
(ii) isolating the onium perchlorate salt formed in (i), and
(iii) dissolving the onium perchlorate salt isolated in (ii) in an organic solvent.

21. The process as claimed in claim 20, wherein the at least one organic compound in (1) is selected from the group consisting of water-soluble organic onium chlorides, and wherein the at least one perchlorate compound in (2) is silver perchlorate.

22. The process as claimed in claim 20, wherein the at least one organic compound in (1) is selected from the group consisting of organic onium chlorides and the at least one perchlorate compound in (2) is selected from the group consisting of alkali metal perchlorates.

23. A process for producing a stabilizer composition comprising reacting:
(1) at least one organic compound selected from the group consisting of organic onium salts and organic compounds capable of forming an onium salt with
(2) an aqueous solution comprising at least one selected from the group consisting of aqueous perchloric acid and an aqueous solution of an inorganic salt of perchloric acid,
to produce a solution comprising at least one organic onium perchlorate.

24. A polymer composition comprising at least one halogen-containing organic polymer and at least one onium perchlorate.

25. The polymer composition as claimed in claim 24, further comprising at least one non-halogen-containing organic polymer.

26. The polymer composition as claimed in claim 24, wherein the at least one organic onium perchlorate includes at least one compound selected from the group consisting of tricycloalkylsulfonium perchlorates, triarylsulfonium perchlorates, and trialkylsulfonium perchlorates.

27. The polymer composition as claimed in claim 24, wherein the at least one organic onium perchlorate includes at least one compound selected from the group consisting of perchlorates of heterocyclic amino alcohols and perchlorates of alkylamines.

28. The polymer composition as claimed in claim 24, wherein the at least one onium perchlorate includes at least one perchlorate selected from the group consisting of tetra-n-butyl phosphonium perchlorate, triphenylbenzylphosphonium perchlorate, trimethylsulfoxonium perchlorate, 2-ethylcarboxypyridinium perchlorate, formamidinium perchlorate, perchlorate salt of tris-hydroxyethylisocyanurate, perchlorate salt of 2-(diethylamino)-ethanol, N-(2-hydroxyethyl)-morpholinium perchlorate, and trioctylammonium perchlorate.

29. The polymer composition as claimed in claim 24, wherein the at least one onium perchlorate includes a phosphonium perchlorate.

30. A formed body, comprising the polymer composition as claimed in claim 24.

31. A polymer composition comprising
at least one halogen-containing organic polymer and
a stabilizer composition comprising
at least one organic onium salt of a perchlorate and
at one organic solvent,
wherein the at least one organic onium salt of a perchlorate is present in a concentration of at least 0.05% by weight, based on the total weight of the stabilizer composition.

32. The polymer composition as claimed in claim 31, further comprising at least one non-halogen-containing organic polymer.

33. The polymer composition as claimed in claim 31, wherein the at least one organic onium perchlorate includes at least one compound selected from the group consisting of tricycloalkylsulfonium perchlorates, triarylsulfonium perchlorates, and trialkylsulfonium perchlorates.

34. The polymer composition as claimed in claim 31, wherein the at least one organic onium perchlorate includes at least one compound selected from the group consisting of perchlorates of heterocyclic amino alcohols and perchlorates of alkylamines.

35. The polymer composition as claimed in claim 31, wherein the at least one onium perchlorate includes at least one perchlorate selected from the group consisting of tetra-n-butyl phosphonium perchlorate, triphenylbenzylphosphonium perchlorate, trimethylsulfoxonium perchlorate, 2-ethylcarboxypyridinium perchlorate, formamidinium perchlorate, perchlorate salt of tris-hydroxyethylisocyanurate, perchlorate salt of 2-(diethylamino)-ethanol, N-(2-hydroxyethyl)-morpholinium perchlorate, and trioctylammonium perchlorate.

36. The polymer composition as claimed in claim 31, wherein the at least one onium perchlorate includes a phosphonium perchlorate.

37. The polymer composition as claimed in claim 31, wherein stabilizer composition is present in a concentration of from 0.1 to 10% by weight, based on the total weight of the polymer composition.

38. A formed body, comprising the polymer composition as claimed in claim 31.

39. A method of stabilizing halogen-containing polymers comprising mixing a polymer composition comprising at least one halogen-containing polymer with a stabilizer composition comprising
at least one organic onium perchlorate and
at least one organic solvent,
wherein the at least one organic onium perchlorate is present in a concentration of at least 0.05% by weight, based on the total weight of the stabilizer composition.

40. The method as claimed in claim 39, wherein the polymer composition includes recyclates of halogen-containing polymers.

41. The method as claimed in claim 39, wherein the at least one organic onium perchlorate includes at least one compound selected from the group consisting of tricycloalkylsulfonium perchlorates, triarylsulfonium perchlorates, and trialkylsulfonium perchlorates.

42. The method as claimed in claim 39, wherein the at least one organic onium perchlorate includes at least one compound selected from the group consisting of perchlorates of heterocyclic amino alcohols and perchlorates of alkylamines.

43. The method as claimed in claim 39, wherein the at least one organic onium perchlorate includes at least one perchlorate selected from the group consisting of tetra-n-butyl phosphonium perchlorate, triphenylbenzylphosphonium perchlorate, trimethylsulfoxonium perchlorate, 2-ethylcarboxypyridinium perchlorate, formamidinium perchlorate, perchlorate salt of tris-hydroxyethylisocyanurate, perchlorate salt of 2-(diethylamino)-ethanol, N-(2-hydroxyethyl)-morpholinium perchlorate, and trioctylammonium perchlorate.

44. The method as claimed in claim 39, wherein the at least one organic solvent includes a solvent selected from the group consisting of phthalic acid esters, phthalates, esters of aliphatic dicarboxylic acids, trimellitic acid esters, and phosphoric acid esters.

45. The method as claimed in claim 39, wherein the at least one onium perchlorate includes a phosphonium perchlorate.
